(19) United States
(12) Patent Application Publication
(10) Pub. No.: US 2008/0285156 A1
(43) Pub. Date: Nov. 20, 2008

(54) COLOR LENS

(75) Inventor: JEN-TSORNG CHANG, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/933,984

(22) Filed: Nov. 1, 2007

(30) Foreign Application Priority Data
May 15, 2007 (CN) 200710200621.4

(51) Int. Cl. G02B 1/11; G02B 1/10

(52) U.S. Cl. 359/722

(57) ABSTRACT

A color lens (10) includes a lens body (100) having two opposite surfaces (110, 120). A nano-material layer (130) is formed on one of the surfaces. An anti-reflect layer (140) is formed on the nano-material layer. A protect layer (150) is formed on the anti-reflect layer configured for protecting the nano-material layer and the anti-reflect layer. The nano-material layer is comprised of paint material particles (132) and color pigment.

### BACKGROUND

1. Technical Field

The present invention generally relates to a color lens.

2. Description of the Related Art

In recent years, image pick-up lens systems have been incorporated in mobile terminals such as mobile phones and lap-top computers. Generally, an image pick-up lens system needs to satisfy the oft-conflicting requirements of compactness, low cost, and excellent optical performance. The image pick-up lens system also needs to act as an external appearance element. The appearance requirement of the lens can be satisfied by a multi-layer coating process to form a multi-layer film on the lens to increase the reflection ratio of the lens. However, a quality of the multi-layer coating process is likely to be influenced by the curvature of the lens.

What is needed, therefore, is a color lens having a simple layer structure which can satisfy the appearance requirement of the lens.

### SUMMARY

A color lens includes a lens body having two opposite surfaces. A nano-material layer is formed on one of the surfaces. An anti-reflect layer is formed on the nano-material layer. A protect layer is formed on the anti-reflect layer configured for protecting the nano-material layer and the anti-reflect layer. The nano-material layer is comprised of paint material particles and color pigment.

Advantages and novel features will become more apparent from the following detailed description of the present color lens, when taken in conjunction with the accompanying drawings.

### BRIEF DESCRIPTION OF THE DRAWINGS

Many aspects of the present color lens can be better understood with reference to the following drawings. The components in the drawings are not necessarily drawn to scale, the emphasis instead being placed upon clearly illustrating the principles of the present color lens. Moreover, in the drawings, like reference numerals designate corresponding parts throughout the several views.

FIG. 1 is a schematic view of a color lens in accordance with a first preferred embodiment;

FIG. 2 is an exploded perspective view of a tray device used in a method for manufacturing the color lens illustrated in the FIG. 1;

FIG. 3 is a perspective view of the tray device illustrated in FIG. 2;

FIG. 4 is a schematic, cross-sectional view of the tray device, taken along line IV-IV of FIG. 3; and

FIG. 5 is schematic view of a spaying device used in a method for manufacturing the color lens illustrated in the FIG. 1.

Corresponding reference characters indicate corresponding parts throughout the drawings. The exemplifications set out herein illustrate at least one present embodiment of the color lens, in one form, and such exemplifications are not to be construed as limiting the scope of the invention in any manner.

### DETAILED DESCRIPTION OF THE INVENTION

Reference will now be made to the drawings to describe preferred embodiments of the present color lens, in detail.

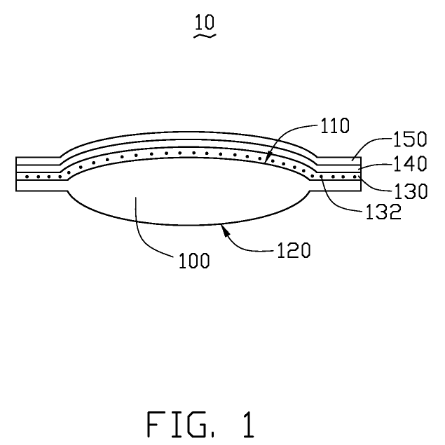

Referring to FIG. 1, a color lens 10 in accordance with a first present embodiment is shown. The color lens 10 includes a lens body 100. The lens body 100 has a first surface 110, and a second surface 120 opposite to the first surface 110. The first surface 110 is coated with a nano-material layer 130, an anti-reflect layer 140, and a protect layer 150, in the order written.

Paint material particles 132 with high reflection ratio are uniformly dispersed in the nano-material layer 130. Since the paint material particles 132 are dispersed uniformly, the influence to the imaging quality induced by the paint material particles 132 is greatly reduced, if not prevented. The paint material particles 132 have an average grain size in a range from about 100 nanometers to about 500 nanometers, preferably, from about 200 nanometers to about 300 nanometers. A thickness of the nano-material layer 130 is in a range from about 100 nanometers to about 1000 nanometers. The paint material particles 132 are comprised of titanium dioxide (TiO₂) particles, silicon dioxide (SiO₂) particles, zinc oxide (ZnO) particles, or the composition thereof. The nano-material layer 130 further includes color pigments for making the color lens 10 present different colors, thereby satisfy the appearance requirement.

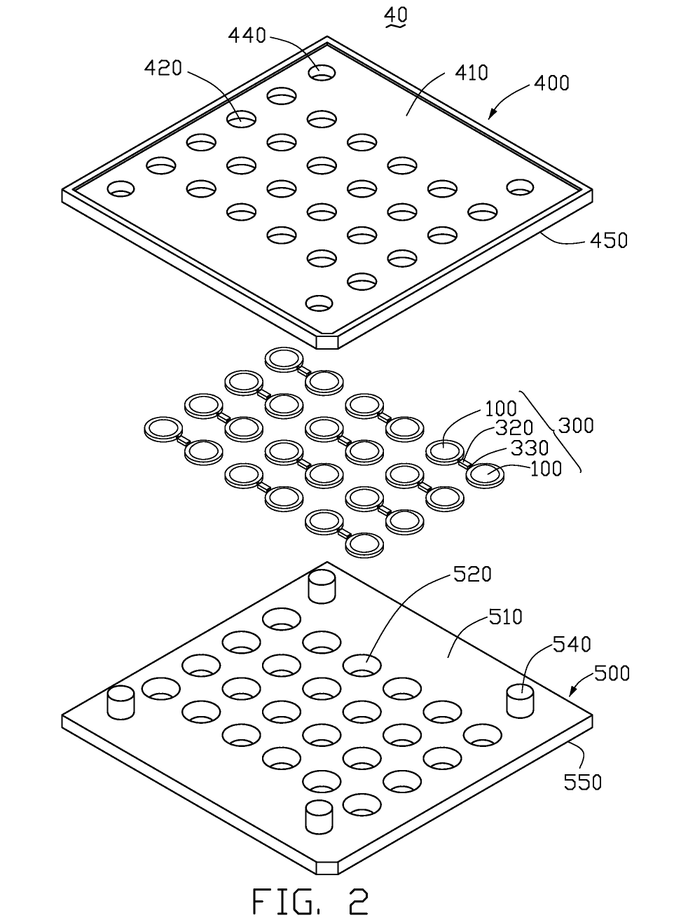

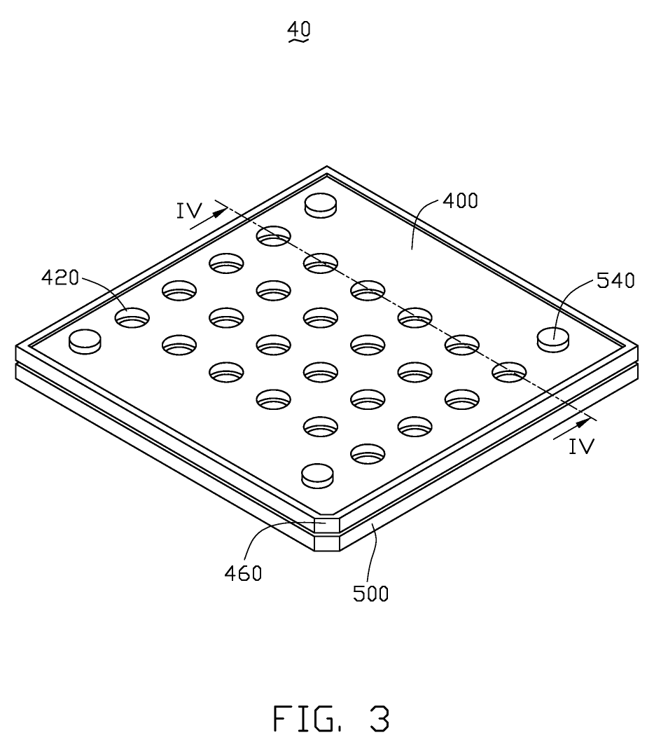

The nano-material layer 130 can be coated on the first surface 110 using a spraying process. Referring to FIGS. 2 to 4 and FIG. 5, a tray device 40 and a spraying system 600 for forming the nano-material layer 130 according to the present embodiment is shown.

Referring to FIG. 2, the tray device 40 includes a first tray 400 and a second tray 500. A plurality of first through holes 420 and a plurality of second through holes 520 are respectively and symmetrically opposite defined in the first tray 400 and the second tray 500. In the present embodiment, the first through holes 420 and the second through holes 520 are evenly spaced apart from each other in a matrix. It is to be understood that, the first through holes 420 and the second through holes 520 can be arranged in an irregular pattern. In the present embodiment, the tray device 40 is shaped as a square. The first tray 400 and the second tray 500 are comprised of metal or plastic.

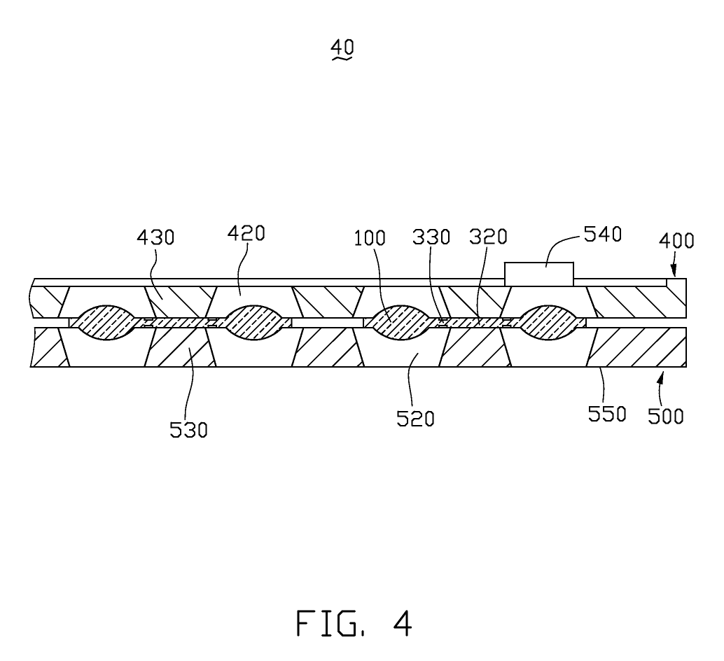

Referring to FIG. 2 and FIG. 4, the structures of the first tray 400 and the second tray 500 are described in detail as follows. The second tray 500 includes a top surface 510 and a bottom surface 550. The diameter of each of the second through holes 520 is little by little decreased from the top surface 510 to the bottom surface 550. The longitudinal section of the second through hole 520 is an inverse-trapezoid. A clamping portion 530 is defined between every two adjacent second through holes 520. Four locating pieces 540 respectively protrude out from each corner of the top surface 510.

The structure of the first tray 400 is approximately symmetrically opposite to the second tray 500. The first tray 400 includes a top surface 410 and a bottom surface 450. The diameter of each of the first through holes 420 is little by little increased from the top surface 410 to the bottom surface 450. The longitudinal section of the first through hole 420 is a trapezoid. A clamping portion 430 is defined between every two adjacent second though holes 420. Four locating holes 440 are respectively defined in each corner of the bottom surface 450.

Prior on performing the spraying process, a plurality of molding lens blanks 300 are provided. Each of the lens blanks 300 includes two lens bodies 100 and a stub bar 320. Two ends of the stub bar 320 are respectively connected with the two lens bodies 100 by two shearing portions 330. It is to be understood that, in alternative embodiments, a lens blank 300 including one lens body 100 and one stub bar 320 connected therewith, or a lens blank 300 including a plurality of lens bodies 100 and a plurality of stub bars 320 connecting the lens bodies 100 in series, may be used. The lens blank 300 is located between the first tray 400 and the second tray 500. Firstly, the lens bodies 100 are set above the second through holes 520. Each of the lens bodies 100 is coaxial with the corresponding through hole 520. Then, the locating pieces 540 are inserted through the locating holes 440, whereby the first tray 400 is assembled with the second tray 500 and the lens blanks 300 are clamped between the first tray 400 and the second tray 500. The smallest diameter of the first through hole 420 and the second through hole 520 is larger than the diameter of the lens body 100.

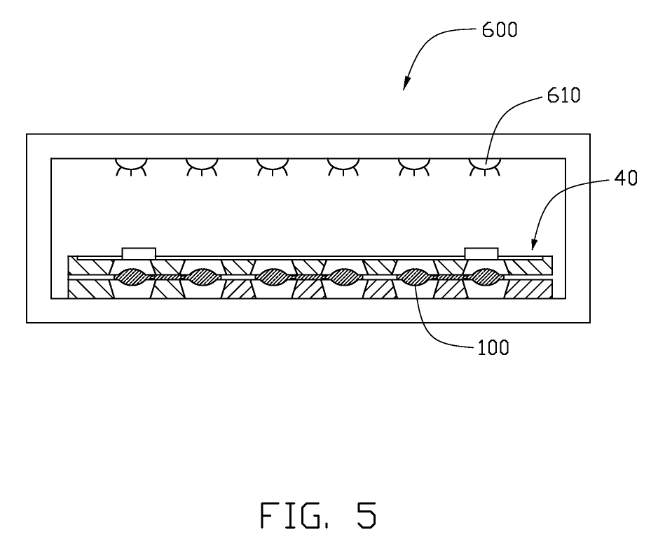

Referring to FIG. 5, during the spraying process, the tray device 40 is delivered into the spraying device 600. The spraying device 600 includes at least one spraying gun 610. The nano-material layer (not shown in FIG. 5) is formed on the lens body 100 by spraying nano-materials via the spraying gun 610. The nano-materials are comprised of paint material particles with high reflection ratio and color pigments. The paint material particles are comprised of TiO₂ particles, SiO₂ particles, ZnO particles, or the composition thereof. Preferably, the at least one spraying gun 610 is attached to the top surface of spraying device 600. At least one spraying gun 610 is opposite to each one of the lens bodies 100, so as to spray each of the lens bodies 100 uniformly. Since the smallest diameter of the first through hole 420 and the second through hole 520 is larger than the diameter of the lens body 100, the lens body 100 can be sufficiently sprayed. It is to be understood that, in alternative embodiments, the tray device can be placed on a rotating stage during the spraying process.

The protect layer 150 is a harden film dispersed with SiO₂ particles or titanium oxide (Ti₂O₅) particles. The protect layer 150 is configured for protecting the nano-material layer 130 and the anti-reflect layer 140. The anti-reflect layer 140 and the protect layer 150 can be formed using an anti-reflection coating process.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A color lens, comprising:
a lens body having two opposite surfaces;
a nano-material layer formed on at least one of the surfaces;
an anti-reflect layer formed on the nano-material layer;
a protect layer formed on the anti-reflect layer configured for protecting the nano-material layer and the anti-reflect layer;
wherein the nano-material layer is comprised of paint material particles and color pigment.

2. The color lens as claimed in claim 1, wherein the paint material particles are uniformly dispersed in the nano-material layer.

3. The color lens as claimed in claim 1, wherein the paint material particles have an average grain size in a range from about 100 nanometers to about 500 nanometers.

4. The color lens as claimed in claim 1, wherein the paint material particles have an average grain size in a range from about 200 nanometers to about 300 nanometers.

5. The color lens as claimed in claim 1, wherein a thickness of the nano-material layer is in a range from about 100 nanometers to about 1000 nanometers.

6. The color lens as claimed in claim 1, wherein the paint material particles are comprised of particles selected from the group consisting of TiO₂ particles, SiO₂ particles, ZnO particles, and any combination thereof.

7. The color lens as claimed in claim 1, wherein the protect layer is a film comprised of at least one of SiO₂ particles and Ti₂O₅ particles.
